(19) United States
(12) Patent Application Publication
(10) Pub. No.: US 2011/0094145 A1
(43) Pub. Date: Apr. 28, 2011

(54) RETRACTABLE FISHING NET HAVING AN ELASTIC AND INCREMENTAL NET EXTENSION SYSTEM

(76) Inventor: Donald James Marx, Rockford, MN (US)

(21) Appl. No.: 12/603,790

(22) Filed: Oct. 22, 2009

(51) Int. Cl. A01K 77/00

(52) U.S. Cl. 43/12; 43/11

(57) ABSTRACT

A new fishing net 10 that has a handle 12, a looped portion 14, a net 16 attached to the looped portion 14, an elastic cord 18 that has a first segment 34 that extends from the handle 12 to an apex region 28 of the net 16, and a cord engagement means 20 that is located on the handle 12 and through which the cord 18 slidably passes to define a second segment 36 of the cord 18. The cord engagement means 20 frictionally engaging the cord 18 to allow the cord 18 to be incrementally extended in length between the handle 12 and the net 16 by exerting tension thereon in the first segment 34 and allowing the cord 18 to be retracted in length by exerting a tension thereon in the second segment 36.

The present invention pertains to a new fishing net, which uses an elastic cord that allows the net to extend when a fish is caught in the net. The present invention also provides a mechanical system that fictionally engages a cord to enable the fishing net to be extended incrementally from a retracted condition.

### BACKGROUND

Many fishermen use boats and fishing poles to catch fish. When a hooked fish is reeled in adjacent to the boat, a net is often used to retrieve the fish from the water. To prevent the net from being tangled before its use, the net is often placed in a retracted condition adjacent to the handle. When the net is needed to retrieve the fish, the net is extended from the handle so that the fish can be scooped from the water.

A variety of systems have been developed for retracting fishing nets for storage and extending them during fish netting—see, for example, U.S. Pat. Nos. 7,322,146, 6,681,515, 4,815,227, 4,571,875, and 3,023,530, 2,688,815, and 2,630,646. While all of these patents describe methods for placing fishing nets in storage and in-use condition, they tend to use somewhat complicated mechanisms for achieving these conditions.

U.S. Pat. No. 7,322,146, for example, uses magnetic connectors to keep the fishing net in a retracted condition. In use, the fishing net is maintained in a retracted condition until the fish is received within the receiving net, whereby the weight of the fish causes the magnets to be separated from each other so that the net can extend. U.S. Pat. No. 6,681,515 uses a pair of couplers located at opposing sides of a material web. When pressure is applied to the net when capturing a fish, the couplers disengage so that the net can become fully extended. U.S. Pat. No. 4,815,227 places a weight slideably within the handle of the fishing net. The weight has sufficient mass to draw the net toward the handle when in its retracted condition. U.S. Pat. Nos. 4,571,875 and 2,630,646 use compression and tension springs, respectively, to allow for retraction and extension of a cord that is attached to the net apex. U.S. Pat. Nos. 3,023,530 and 2,688,815 use rings and hooks or catches to hold the net in a retracted condition until use. The positioning of the apex region of the net also can be controlled by the user when landing a fish. This feature of the invention is beneficial in that it can prevent premature entanglement of the net.

### SUMMARY OF THE INVENTION

In a first embodiment, the present invention provides a new fishing net that comprises a handle, a looped portion, a net that is secured to the looped portion, and an elastic cord that extends from the handle to an apex region of the net. The elastic cord allows the net to be drawn toward the handle when not in use and allows the net to be extended from the handle when a sizable fish is placed in it and is lifted by the user at the handle.

In a second embodiment, the present invention provides a new fishing net that comprises a handle, a looped portion, a net that is attached to the looped portion, a cord that has a first segment that extends from the handle to an apex region of the net, and a cord engagement means that is located on the handle and through which the cord slidably passes to define a second segment of the cord. The cord engagement means frictionally engages the cord to allow the cord to be incrementally extended in length between the handle and the net by exerting tension thereon in the first segment and to allow the cord to be retracted in length by exerting a tension thereon in the second segment.

The present invention differs from the retractable fishing nets by providing different and beneficial mechanisms for allowing the fishing net to be expanded from a storage condition and to be retracted back into that condition. In one embodiment, the elastic cord is used to draw the fishing net into its retracted condition. When a fish is captured in the net, the elastic cord can stretch to allow the net to move away from the handle towards a draped condition. Once the fish is removed from the net, the elastic cord assists in returning the net back to its retracted storage condition. There is no need for the user to reattach magnets, hooks, or couplers to bring that back into its storage condition. The elastic cord thus provides a very efficient way for permitting expansion and contraction of the net with little input by the user. The frictionally engagement mechanism is beneficial in that the user can quickly expand the cord length of the first segment, located between the net apex region and the handle, so that the net can be displaced rapidly from its storage condition. Using frictional engagement, the net can be expanded into its fully draped condition when a large fish is captured, or it can be expanded into a semi-draped condition when a medium sized or smaller fish is captured in the net.

### GLOSSARY

In this document:
“apex region” means the general region that would define the lowermost portion when allowed to drape towards the ground under gravity;
“cord” means a string or rope of twisted or interwoven fibers or strands or an elongated band;
“elastic” means having the ability to be stretched to at least about 100% of the unstretched length when a tensile force is applied thereto and to return the unstretched length without exhibiting permanent damage when the tensile force is removed;
“fishing net” means a device that is sufficiently porous to allow water to pass therethough but is sufficiently enclosed to allow a fish to be trapped therein;
“handle” means a portion or part that is configured for being grasped by one or more hands of a person or the solid portion that extends from the looped portion and has a region for being grasped by a person;
“incrementally” means changed in a controllable or desirable manner;
“net” means an openwork fabric made of filaments, threads, cords, ropes, or the like that are woven, knotted, or otherwise joined together and generally regular intervals;
“sizable” means greater than one pound.

### BRIEF DESCRIPTION OF THE DRAWINGS

FIG. 1 is a perspective view of a fishing net 10 in retracted condition in accordance with the present invention.

FIG. 2 is a perspective view of a fishing net 10 in extended condition in accordance with the present invention.

### DETAILED DESCRIPTION OF PREFERRED EMBODIMENTS

In describing different embodiments of the invention, specific terminology is generally used for the sake of clarity. The invention, however, is not intended to be limited to the specific terms so selected, and each term so selected includes all technical equivalents that operate similarly.

In the practice of the present invention, a new fishing net is provided which, in a first embodiment, can be extended from a retracted condition without input from the user. That also can be returned to its retracted condition also without input from the user. Once the fish is removed from the net, the elastic condition of the cord allows for immediate retraction of the net towards a handle. In a second embodiment of the present invention, user input can enable the cord length to be altered in a segment between the apex of the fishing net and its point of frictional engagement adjacent to the handle. The user can grasp the cord and apply tension to it because the cord to be drawn through the frictional engagement mechanism so that the cord length can be extended as desired. If the elastic nature of the cord does not allow for sufficient extension of the cord length by itself—for example, when the fish weight is not great enough to enable them not to reach an adequate extension from the handle—the user can apply tension to the cord to further extend its length to an appropriate dimension.

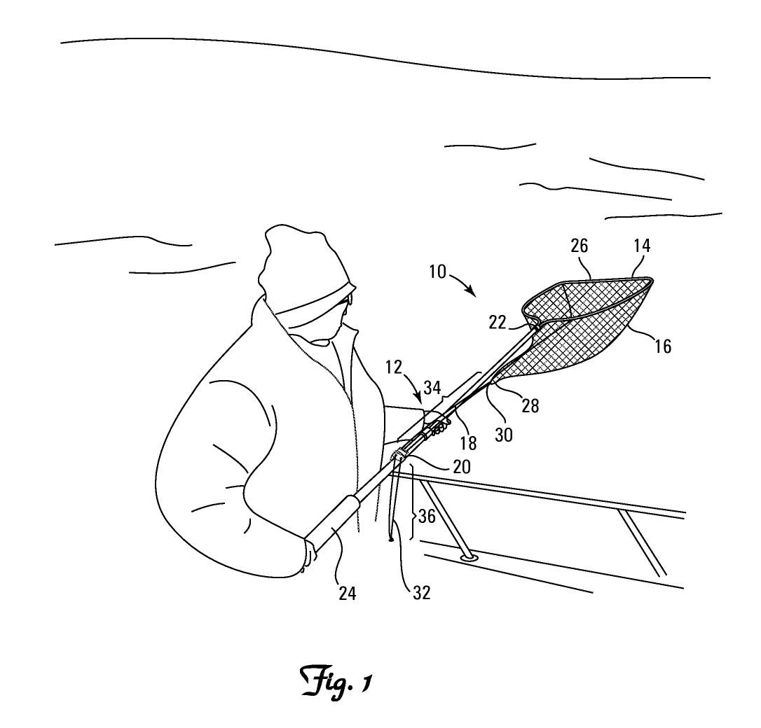

FIG. 1 shows a fisherman holding a fishing net 10 that has a structure according to the present invention. The fishing net 10 is shown in its retracted condition and includes a handle 12, a looped portion 14, a net 16, a cord 18, and a frictional engagement mechanism 20. The handle 12 has first and second ends 22 and 24, respectively. The looped portion 14 extends from the first end 22 of the handle 12. The net 16 is attached to the looped portion 14 at a first open end 26 of the net. A first end 30 of the cord 18 is attached to the net 16 at a second end or apex region 28. A second end 32 of the cord 18 extends freely beneath the handle 12. The cord 18 thus passes through the frictional engagement mechanism 20 between the first end 30 and the second end 32 of the cord 18.

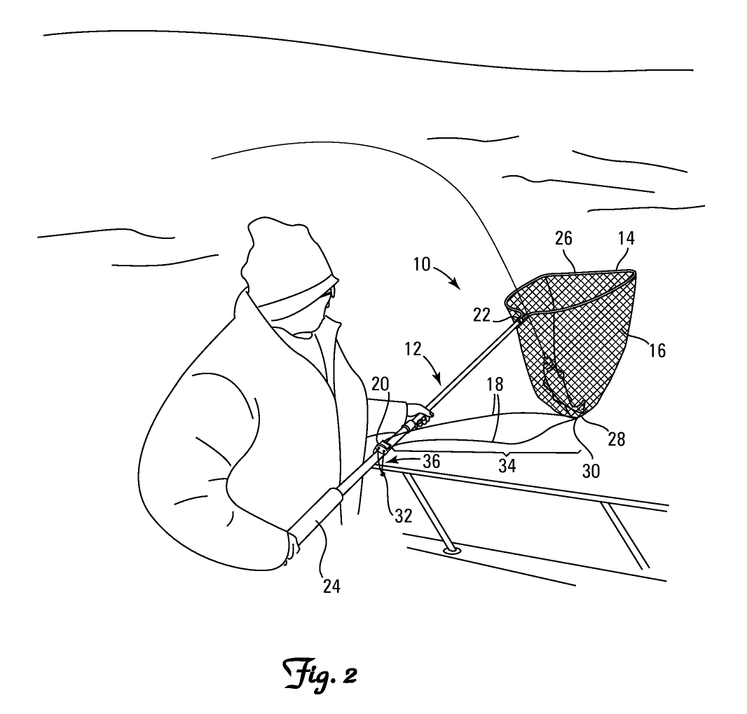

FIG. 2 illustrates the fishing net 10 in an expanded condition, as which may be achieved when a fish is captured in the net 10. In the expanded condition, the cord 18 is extended in length in a segment 34 located between the apex region 28 of the net 16 and the point of engagement with the frictional engagement mechanism 20. The cord 18 can be extended in length as a result of a tensile force applied to the cord 18 by the weight of the fish. The length of the cord 18 in the first segment 34 also can be extended as a result of the fisherman drawing the cord 18 the mechanism 20 so as to extend the length in the first segment 34 and thereby shorten the length in the second free segment 36. After the fish has been removed from the net 16, the cord length in the first segment 34 can be shortened as a result of the cord contracting and/or the fisherman applying a tensile force to the cord 18 in the second segment 34 to thereby draw it through the frictional engagement mechanism 20. The cord length in the first segment 34 can be shortened to such an extent that the net apex 28 is juxtapositioned against the frictional engagement mechanism 20 such that the first segment 34 has little or no length. In a fully extended condition, the cord 18 can be drawn through the frictional engagement mechanism 20 in the opposite direction such that the first segment 34 acquires essentially the full length of the cord 18 such that the second segment length 32 is minimized.

The cord may have a total length of about 12 to 30 inches, more typically about 18 to 24 inches. The cord may be elastic in nature such that it can be extended to at least about 100%, 125%, 150%, and even greater than 200% of its original natural length, when a tensile force is applied to it, without damaging the elastic properties of the cord to thereby enable the cord to return to its essential original, natural length. The fishing net of the present invention also may include one or more cords 18, which extend from the apex 28 of the net 16 through the frictional gaiter mechanism 20. Typically, one or two elastic cords is sufficient to allow for that retraction and extension according to the present invention. When the cord has a small diameter, for example, less than ⅛ of an inch, a pair of elastic cords 18 may be suitably provided to carry out the retraction and extension abilities of the inventive net.

The frictional engagement mechanism may be essentially any device that allows the cord to be drawn therethrough in a frictional manner—that is, at least some noticeable resistance is applied to the cord by the mechanism when it is being drawn therethrough. The amount of friction should be sufficient enough to allow for incremental adjustment but not be so great, however, that a user has difficulty drawing the cord through the mechanism in either direction. The frictional engagement mechanism should be fashioned so that it tends to snugly engage the cord. The snug engagement may be achieved using a variety of different techniques. For example, the frictional engagement mechanism could be spring-loaded, or it could have an opening having a diameter that is slightly less than the cord diameter so that there is purely a physical engagement rather than a physical and mechanical engagement. In a spring loaded device, a member can be forced into frictional engagement with the cord(s) as it passes through an opening in the device. The spring may be in tension or compression, pulling the member toward the cord(s). The member could have one or more openings and be slidably positioned in the housing that also has one or more openings. When the openings are forced out of alignment by the spring, the member engages the cord(s) to cause the frictional engagement. A variety of other engagement techniques could be used as contemplated by persons of ordinary skill, now or in the future. An example of a commercially-available frictional engagement mechanism is a Dritz® cord stop, available from Prym Consumer USA Inc, of Spartanburg, S.C. The frictional engagement mechanism is preferably attached to the handle such that the cord passes through the mechanism at a lower point (bottom of the circular cross section) when the net is held in an upright position as shown in FIG. 2.

The net, looped portion, and handle of the fishing net of the present invention may be typical nets and handles as our commonly provided on a variety of commercially-available fishing nets. The patents cited above, for example, described a variety of nets, looped portions, and handles that could be used in conjunction with the present invention.

This invention may take on various modifications and alterations without departing from the spirit and scope thereof Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background Section, are incorporated by reference into this document in total. To the extent that there is a conflict, the present specification will control.

What is claimed is:

1. A fishing net that comprises;
(a) a handle;
(b) a looped portion;
(c) a net secured to the looped portion; and
(d) an elastic cord that extends from the handle to an apex region of the net, the elastic cord allowing the net to be drawn toward the handle when not in use and allowing the net to be extended from the handle when a sizable fish is placed therein and is lifted by the user at the handle.

2. The fishing net of claim 1, wherein the elastic cord is about 18 to 24 inches in length between the net and the handle when in a retracted condition.

3. The fishing net of claim 1, wherein the elastic cord can be stretched to about 125% of its natural length and return to its original length without damage thereto.

4. The fishing net of claim 1, wherein the elastic cord can be stretched to about 150% of its natural length and return to its original length without damage thereto.

5. The fishing net of claim 1, wherein the elastic cord can be stretched to about 200% of its natural length and return to its original length without damage thereto.

6. The fishing net of claim 1, wherein the cord is attached to the handle at a mechanism that frictionally engages the cord so as to allow for a length extension or contraction between the apex of the net and a point of engagement at the frictional engagement mechanism.

7. A fishing net that comprises:
(a) a handle;
(b) a looped portion;
(c) a net attached to the looped portion;
(d) a cord that has a first segment that extends from the handle to an apex region of the net; and
(e) a cord engagement means that is located on the handle and through which the cord slidably passes to define a second segment of the cord, the cord engagement means frictionally engaging the cord to allow the cord to be incrementally extended in length between the handle and the net by exerting tension thereon in the first segment and allowing the cord to be retracted in length by exerting a tension thereon in the second segment.

8. The fishing net of claim 9, wherein the cord comprises first and second parallel cords that each have first and second segments and that work in concert with each other to extend and retract the net from the handle.

9. The fishing net of claim 7, wherein the cord is elastic.
